(19) United States
(12) Patent Application Publication
(10) Pub. No.: US 2026/0086841 A1
(43) Pub. Date: Mar. 26, 2026

(54) SYSTEM AND METHOD FOR ITERATIVE APPLICATION DEVELOPMENT

(71) Applicant: Jebin Benjamin Vimala, Kanyakumari (IN)

(72) Inventor: Jebin Benjamin Vimala, Kanyakumari (IN)

(21) Appl. No.: 19/031,515

(22) Filed: Jan. 18, 2025

(30) Foreign Application Priority Data
Sep. 24, 2024 (IN) 202441072042

(51) Int. Cl. G06F 9/455; G06F 8/40

(52) U.S. Cl. CPC G06F 9/45558; G06F 8/40; G06F 2009/45562; G06F 2009/45595

(57) ABSTRACT

A system is configured to receive plurality of application program interface (API) requests corresponding to plurality of API logics from a client device. For a first API request, including a first path to access a first API logic, the system determines availability of an existing first virtual machine configured for the first path or create a second virtual machine for the first path when the existing first virtual machine is unavailable. The system configures the second virtual machine with the first API logic received from an application server. The system reconfigures the existing first virtual machine or the second virtual machine with a modified first API logic from the application server based on the first path. A response to the first API request may be provided based on the first API logic or the modified API logic.

### TECHNICAL FIELD

The present disclosure relates to application development. More particularly, the present disclosure relates to iterative application development and on-demand application deployment on a virtual machine.

### BACKGROUND

Typically, a service may include multiple microservices, and a microservice may be defined by multiple Application Programmable Interfaces (API) logics. A microservice may have the API logics bundled together. An API logic defines an end point in a microservice and may be understood as a set of procedures or protocols. APIs allow interactions between the API logics/applications. Further, the APIs may be utilized to deliver a client's request to a server and to return a response back to the client. The service may be deployed on cloud platforms like Amazon web Services® or Microsoft Azure®. The cloud platforms provide scalability of resources and deployment of virtual machines/servers at strategical geographic locations to reduce latency. A virtual machine may be configured to deploy a complete service. Alternatively, in a distributed architecture, separate virtual machines may be configured to deploy one or more microservices, instead of the complete service.

When API logic of a microservice is modified or redeveloped, the entire microservice is required to be built again and redeployed on a virtual server or a physical server. In a development environment, multiple API logics for a microservice are developed and modified simultaneously by multiple developers (developer client). During development, modification of API logics is an iterative process and results in frequent updating of the entire microservice to reflect the modification and for the purpose of testing the modified API logics. As a result, the developers may experience delay in deploying and testing proper functionality of the microservice. Further, simultaneous modification of the API logics may also introduce functional errors between the API logics of the microservice, which may render the complete microservice inoperative.

Moreover, no-code platforms and low-code platforms allow developers to directly provide API logics, instead of writing a complete code, through predefined templates or units of task in form of a graphical user interface. A developer may configure and combine the predefined units to create an API logic. A slight adjustment or modification in a template of an API logic would also result in generation of fresh code and thereafter rebuilding and redevelopment of entire microservice. Further, continuous integration and continuous delivery/deployment (CI/CD) processes streamline and accelerate a software development lifecycle. Continuous integration is a process of automatically and frequently integrating code changes into a shared source code repository and continuous delivery and/or deployment is a process for integrating, testing, and delivering of code changes. However, a change in a single line of code for an API in a microservice may require the complete microservice to follow entire CI/CD process before the change may be reflected on a production site.

Each modification in microservice and testing of the same may initiate multiple and frequent cycles of building and redeployment of the microservice. Therefore, existing processes for developing an application/service are inefficient, as the whole process of deployment and testing are being recreated and which consumes sufficient time and computing resources to reflect the desired output. Specifically, during the development environment where the API logics are frequency modified along with multiple versions of such API logics are being generated.

U.S. Patent Publication No. 20130275968 discloses a platform for managing one or more applications running on one or more virtual machines. The platform allows users to deploy multiple applications in a managed environment. Further, the platform allows the users to configure applications, start applications, suspend applications, and stop applications. Further, the platform provides support for monitoring status or “health” of an application running on one or more systems or virtual machines. The platform includes a load balancer and an orchestrator 108. The load balancer receives requests and other information from user systems, analyzes the received request, and routes the request to one of multiple virtual machines hosting an application associated with the request.

U.S. Patent Publication No. 20160124742 discloses an application development framework system comprising a microservice platform for developing and executing a plurality of microservices, wherein each microservice of the microservices comprises an independently-deployable service configured to execute one or more functions to fulfill an interface contract for an interface for the microservice; and an orchestration platform for developing and executing an orchestrator to orchestrate the microservices to execute an interconnection platform for a cloud-based services exchange configured to interconnect, using one or more virtual circuits, customers of the cloud-based services exchange.

### SUMMARY

In one aspect, the present disclosure relates to a system and a method for iterative application development. The system may include a processor which is configured to receive, from a client device, a first application program interface (API) request corresponding to a first API logic. The first API request may include a first path to access the first API logic of one or more API logics. In response to receiving the first API request, the processor may determine an availability of an existing first virtual machine configured with the first API logic received corresponding to the first path from an application server or create a second virtual machine for the first path when the existing first virtual machine for the first path is unavailable. The second virtual machine created may be configured with the first API logic received from the application server. Further, the processor may receive a modified first API logic corresponding to the first path from the application server, reconfigure the existing first virtual machine or the second virtual machine for the first path based on the modified first API logic, and provide, to the client device, an output based on the modified first API logic via the updated existing first virtual machine or the updated second virtual machine.

In accordance with an example implementation, the first API request may include a first logical address associated with the first API logic. The first logical address includes the first path and at least one of: a version number of the first API logic, a target programming language associated with the first API logic, and a runtime configuration of the first API logic. Further, the first path defined in the first API request may include a domain name.

In accordance with an example implementation, the second virtual machine may be created by obtaining, from the application server, a first API code corresponding to the first API request, configuring the second virtual machine based on the first API code obtained, and registering the second virtual machine corresponding to the first path for virtual machine discovery. The first API code may be generated by converting the first API logic into the first target programming language.

In accordance with an example implementation, the obtained first API code may be stored in a second virtual machine storage with an access restricted to the second virtual machine. A synchronization flag may be assigned to the first path. A status of the synchronization flag enables receiving of a modified first API code from the application server, such that the modified first API corresponds to the modified first API logic. Further, the synchronization flag may be assigned to the first path for a first predetermined time.

In accordance with an example implementation, the modified first API code is generated by converting the modified first API logic into the first target programming language. When the system receives the modified first API code from the application server, the system updates the second virtual machine storage with the modified first API code by replacing the first API code stored prior to the update with the modified first API code or identifying one or more differences between the first API code stored prior to the update and the modified first API code, and updating the first API code prior to the updated with the one or more identified differences.

In another example implementation, the system includes a no-code platform for inputting one or more user interface elements associated with the first API logic.

In another example implementation, the existing first virtual machine or the second virtual machine may be deleted after a predetermined time of inactivity of the existing first virtual machine or the second virtual machine.

In accordance with an example implementation, the first virtual machine may be configured with at least two API logics of the one or more API logics, such that, the at least two API logics are bundled and accessed through their respective unique paths. The first virtual machine may be configured to manage the at least two API logics simultaneously and a volume of the API requests managed by the first virtual machine and one or more virtual machine utilization parameters associated with the first virtual machine may be monitored by the system. The monitored volume and the one or more monitored virtual machine utilization parameters may be stored in a monitoring storage. The one or more virtual machine utilization parameters may include a response time of the first virtual machine corresponding to the plurality of first or different API requests, a resource or bandwidth utilization associated with each API request, and a count of instances of receiving the modified API codes.

In accordance with an example implementation, at least one candidate API logic may be identified from the at least two API logics, which is to be removed from the first virtual machine. The candidate API logic may be based on at least one of: the response time being greater than a threshold response time, the resource or bandwidth utilization being greater or lower than a threshold resource utilization, the count of instances of receiving the modified API codes from the application server being greater or lesser than a predetermined count of instances, and the volume of the API requests being greater or lesser than a threshold volume.

In accordance with an example implementation, the candidate API may be configured on another virtual machine. Accordingly, an availability of an existing third virtual machine may be determined based on the determined volume of the API requests and the one or more monitored virtual machine utilization parameters associated with the third virtual machine. Alternatively, a fourth virtual machine may be created for configuring with the candidate API logic when the existing third virtual machine is unavailable. The fourth virtual machine may be configured with the candidate API logic received from the application server or from the first virtual machine. Thereafter, the candidate API logic is removed from the first virtual machine, a candidate path is defined for the candidate API logic and the existing third virtual machine or the fourth virtual machine is registered corresponding to the candidate path for virtual machine discovery.

In another aspect, the system includes an orchestrator. The application server communicates with the system and the client device. The application server may include a processor and configured to receive an API logic and a path associated with the API logic from the client device. The application server may determine the status of the synchronization flag assigned by the orchestrator corresponding to the path of the API logic. Thereafter, based on the status of the synchronization flag, the application server may provide an API code and an API configuration information corresponding to the path of the API logic to the orchestrator.

In an example implementation, the orchestrator requests for the API code corresponding to the path from the application server. Based on the received request, the application server may provide the API code to the orchestrator. The request may include at least one of a version number, a target programming language, or a combination of the version number and a target programming language associated with the API logic corresponding to the path.

In an example implementation, the API logic may be stored in a database of the application server may be modified by a client. The application server may receive a modified API logic corresponding to the path of the API logic from the client device. The application server may update the API logic, corresponding to the path, stored in the database with the modified API logic. After that, the application server may determine the status of the synchronization flag corresponding to the path from the orchestrator by requesting the orchestrator to provide the status of the synchronization flag associated with the path of the API logic. Based on the status of the synchronization flag, the application sever may provide the modified API code corresponding to the path to the orchestrator.

Numerous advantages and benefits of the inventive subject matter disclosed herein will become apparent to those of ordinary skill in the art upon reading and understanding the present specification. It is to be understood, however, that the detailed description of the various embodiments and specific examples, while indicating preferred and/or other embodiments, are given by way of illustration and not limitation. Many changes and modifications within the scope of the present disclosure may be made without departing from the spirit thereof, and the disclosure includes all such modifications.

### BRIEF DESCRIPTION OF THE DRAWINGS

FIG. 1A is an exemplary illustration of a first environment for iterative application development, in accordance with some embodiments of the present disclosure;

FIG. 1B is an exemplary illustration of a system in the first environment of FIG. 1, in accordance with some embodiments of the present disclosure;

FIG. 2A is an exemplary illustration of a resource pool provided in the first environment of FIG. 1, in accordance with some embodiments of the present disclosure;

FIG. 2B is an exemplary illustration of transferring an API logic from a virtual machine to another virtual machine in the resource pool of FIG. 2A, in accordance with some embodiments of the present disclosure;

FIG. 3 is an exemplary illustration an example implementation of an application server provided in the first environment of FIG. 1, in accordance with some embodiments of the present disclosure;

FIG. 4 is an exemplary illustration of a second environment for iterative application development, in accordance with some embodiments of the present disclosure;

FIG. 5 is an exemplary illustration sequence diagram of a process for request driven API deployment according to FIG. 1, in accordance with some embodiments of the present disclosure;

FIG. 6 is an exemplary sequence diagram of a process for creating an API logic and a deployment thereof, in accordance with some embodiments of the present disclosure;

FIG. 7 is an exemplary sequence diagram of a process for request driven API deployment according to FIG. 4, in accordance with some embodiments of the present disclosure; and

FIGS. 8A and 8B are an exemplary flowchart of a method for managing plurality of API logics on a virtual machine, in accordance with an embodiment of the present disclosure.

### DETAILED DESCRIPTION

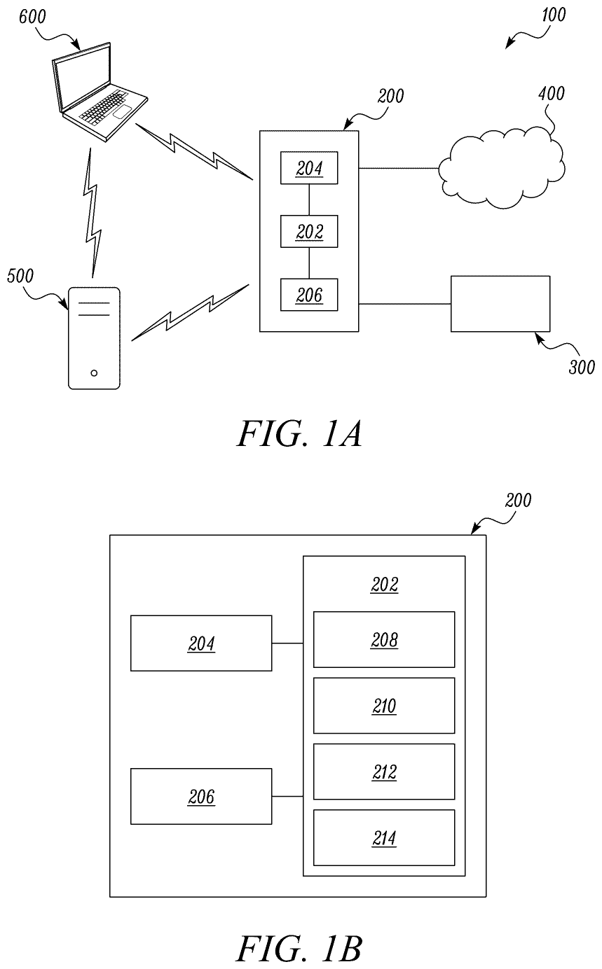

Referring to FIG. 1, a first environment 100 for iterative application development is shown and described, in accordance with some embodiments of the present disclosure. The first environment 100 includes a system 200 for deploying a service, or microservice(s) or application program interface(s) API(s)), a resource pool 300, a cloud service provider 400, an application server 500, and a client device 600.

The system 200 includes a processing module 202, a memory 204, and a network interface 206. The processing module 202 may be coupled to the memory 204 and the network interface 206. The network interface 206 provides a means for the processing module 202 to establish a network connection with the external entities, for example, but not limited to, the client device 600, the application server 500, the resource pool 300, and the cloud service provider 400.

Further, the system 200 is configured to support iterative application development as will be discussed below. The system 200 may be implemented as a server, more particularly as a microservice server. The system 200 creates, configures, and manages virtual machines at the resource pool 300 or at the cloud service provider 400. The system 200 provides a centralized point for the client devices 600 to interact with an appropriate microservice or interact directly with an API logic of the microservice.

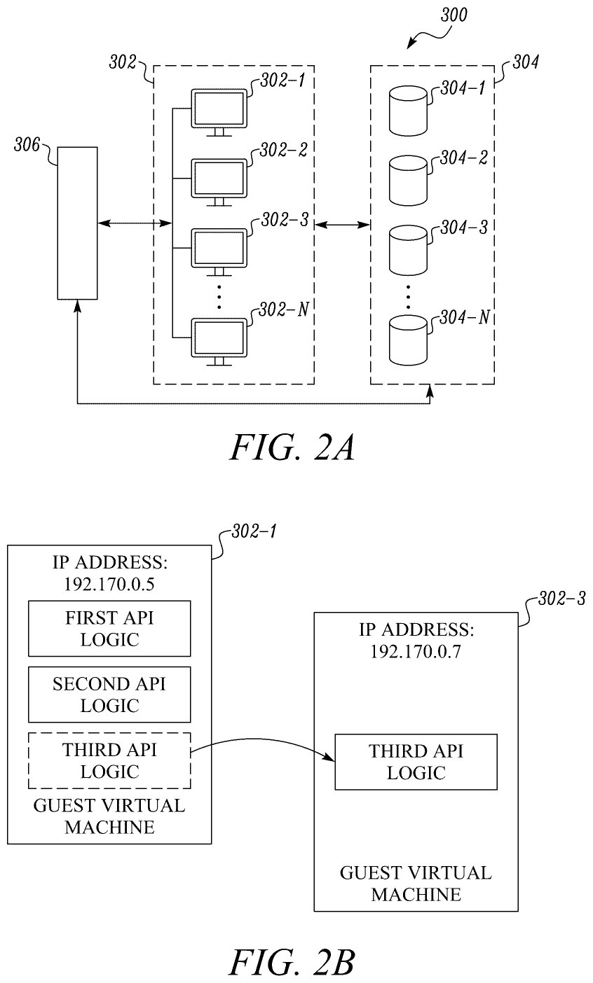

The system 200 may configure virtual machine(s) (302-1 to 302-N of FIG. 2A) to deploy multiple API logics of a microservice individually. In some embodiments, the virtual machine(s) may correspond to computational resources. The virtual machine(s) in the resource pool 300 or at the cloud service provider 400 may be configured with processing power(s) required for the applications to be executed in different operating systems, or to test applications in a safe, sandboxed environment. The virtual machines may be provided for hardware virtualization, software virtualization, storage virtualization, or network virtualization. The resource pool 300 may be referred to as a private cloud.

For example, each of the multiple API logics of the microservice may be configured on the individual virtual machines. The system 200 maintains a registry which provides a mapping between network address(es), e.g. internet protocol (IP) address(es), of the configured virtual machine(s) and paths defined to access API logics deployed on the configured virtual machine(s) for virtual machine discovery. Each API logic has a unique path created by a developer during development stage, such that a virtual machine configured with the API logic may be registered with corresponding unique path for service discovery.

In some embodiments, the system 200 may configure a virtual machine with two separate API logics. Accordingly, an IP address of the virtual machine may be registered with two unique paths corresponding to the two API logics for service discovery. The path for the API logic may include a domain name, universal resource locator, universal resource identifier, index number, sub-path, or version number. For example, the path may be defined as ‘healthcare.com/user/profile’, in which, ‘heatlhcare.com’ may be the domain name defining a service, ‘user’ may define a microservice pertaining to management of user(s) registered for the service, and ‘profile’ may define an API logic configured to manage personal/bibliographic details of the user. Similarly, the path ‘healthcare.com/user/login’ may be defined for an API logic configured to authenticate a user registered for the service provided under the domain healthcare.com. In another example, the path ‘healthcare.com/user/manage-password may be defined for an API logic configured to reset a password of the registered user.

Further, the system 200 may be configured to deploy multiple versions of an API logic either on a single virtual machine or on multiple virtual machines. Therefore, an API request for accessing a specific version of the API logic may include a combination of the path and version number. Further, in absence of the details about the version number in the API request, the system 200 may either respond to the API request based on an earliest version of the corresponding API logic, or the API logic with latest version number.

The system 200 provides an environment for iterative application development, where the processing module 202 is configured to receive, from the client device 600, one or more API requests corresponding to one or more API logics. Each API request includes a unique path to access a corresponding API logic. For example, a first API request of the one or more API requests includes a first path to access a first API logic of the one or more API logics. For each API request, the processing module 202 determines a path included in the API request and accordingly determines whether any existing virtual machine is configured with the determined path, else the processing module 202 configures a new virtual machine for the determined path. For example, the processing module 202 determines an availability of an existing first virtual machine 302-1 (see FIG. 2A) configured with the first API logic received corresponding to the first path from the application server 500 or create a second virtual machine 302-2 (see FIG. 2A) for the first path when the existing first virtual machine 302-1 for the first path is unavailable. The second virtual machine 302-2 may be configured with the first API logic received from the application server 500. Further, the processing module 202 is configured to receive a modified first API logic corresponding to the first path from the application server 500. Based on the received modified first API logic, the processing module 202 reconfigures the existing first virtual machine 302-1 or the second virtual machine 302-2 for the first path based on the modified first API logic and provides, to the client device 600, an output based on the modified first API logic via the updated existing first virtual machine 302-1 or the updated second virtual machine 302-2.

FIG. 1B is an exemplary illustration of the system 200 in the first environment 100, in accordance with some embodiments of the present disclosure. The processing module 202 of the system 200 may be configured with an API gateway module 208, a service discovery module 210, and an orchestrator module 212. The system 200 may include functionality of API gateway server through API gateway module 208. The API gateway module 208 may be implemented as a proxy server between a client and microservices and may act as a centralized entry point for all client requests (API request/call) into the system 200. Further, the API gateway module 208 forwards the client requests to the appropriate virtual machine configured with the requested API logic.

In an example implementation, the API gateway module 208 further performs authentication of the client, access control, protocol translation, response formatting and threat protection, and may also perform load balancing either directly or through a load balancer module 214 configured in the system 200.

The API gateway module 208 may communicate with the service discovery module 210. Based on the API request from the client device 600, the API gateway module 208 determines, via the service discovery module 210, the service, microservice, or API logic that should handle the API request and the virtual machine configured for executing the API request. The service discovery module 210 maintains the registry which stores all the instances of the microservices and/or API logics and addresses of the virtual machines configured with the microservices and/or the API logics.

The system 200 may create a virtual machine and configure the virtual machine with the requested API logic on demand. Further, the system 200 may delete an instance of the API logic after executing the API request or may delete the virtual machine after a predetermined time of inactivity. Therefore, in virtual environment, the number of active virtual machines keep changing and accordingly the location of microservices and/or API logics also keep on changing dynamically. The service discovery module 210 maintains mapping between network addresses of the virtual machines and the logical addresses defined to access the microservices/API logics configured on the virtual machines. The network address may correspond to IP addresses assigned to the virtual machine. For example, when the system 200 configures the first virtual machine 302-1 with the first API logic, the registry at the service discovery module 210 stores the first virtual machine's Internet Protocol (IP) address, such as IPv4 or IPv6 or Media Access Control (MAC) address, and a corresponding first logical address associated with the first API logic. The first logical address may include the first path (URL or URI) and additional information associated with the first API logic such as, but not limited to, version number, environment, programming language, operating system, and runtime configuration like memory size requirement (Random Access memory (RAM) or Hard Drive) and processing power requirements (CPU), etc. As a result, virtual machines currently in operation may be discovered via the service discovery module 210.

In an example implementation, the service discovery module 210 may receive a service discovery query from the API gateway module 208. The service discovery query is based on the API request which may include the path of the requested API logic and the additional information related to the requested API logic. In response, the service discovery module 210 may look up the registry and return either the network address (i.e. IP address, MAC address, or port details) of a virtual machine configured with the API logic or return an error (HTTP 404 message). In some embodiments, the error may indicate that none of the existing virtual machines are configured with the requested API logic. In some embodiments, the error may indicate that the request has been made for a first time for the API logic, and therefore, a virtual machine has not yet been configured for the requested API logic. In some embodiments, the error may also indicate that the virtual machine configured for the requested API logic may have been deleted due to inactivity.

The registry maintained at the service discovery module 210 may include a mapping between logical addresses of API logics and the corresponding virtual machines configured with the API logics. In one aspect, a logical address for accessing an API logic may be defined as a unique path and one or more following parameters: version number, programming language, or runtime configuration. Table-1 below illustrates an example mapping between the logical addresses of API logics and the corresponding virtual machines configured with the API logics.

TABLE 1

| S. | Lookup key | Virtual Machine |
|---|---|---|
| No. | (logical address of API logics) | IP address |
| 1. | prod.users.exmproject.com/users/list ver: 1 | 192.169.0.2 |
| | lang: js r: 256M; c: 1; d: 5G | 192.170.0.5 |
| 2. | prod.users.exmproject.com/users/list ver: 2 | 192.170.0.7 |
| | lang: rust | |
| 3. | prod.users.exmproject.com/users/list ver: 1 | 192.171.1.2 |
| 4. | prod.data.exmproject.com/sources/list ver: 1 | 192.166.1.2 |
| | lang: js r: 256M; c: 1; d: 5G | 193.171.4.1 |
| 5. | prod.data.exmproject.com/sources/list ver: 2 | 192.170.1.4 |
| | lang: rust | |
| 6. | prod.data.exmproject.com/sources/list ver: 1 | 194.175.2.2 |
| | | 194.175.5.3 |

Referring to Table-1, the lookup key has list of six paths (logical addresses) defined for six API logics (endpoints). Entries at serial numbers 1, 4, and 6, indicate that two virtual machines have been configured for each of the API logics such that a high volume of API requests received corresponding to the paths provided at the at serial numbers 1, 4, and 6 may be addressed or fulfilled. As shown in Table-1, the logical address is a combination of the path “prod.users.exmproject.com/users/list”, version number “ver:1”, programming language “lang:js”, and configuration information “r:256M; c:1; d:5G”. The logical address has the path as the mandatory parameter and the additional parameters are the version number, the programming language, and the configuration information. In absence of a version number in an API request, the service discovery module 210 returns a virtual machine IP address based on the latest version or the root/first version available in the lookup key.

Further, Table-1 indicates that a single API logic defined by the path “prod.users.exmproject.com/users/list” may be deployed in various configurations at different virtual machines. For example, entry at serial number 1 indicates deploying the API logic with JavaScript (js) programming language and entry at serial number 2 indicates deploying the API logic with rust programming language. Further, the registry of the service discovery module 210 may have multiple entries for multiple endpoints of a microservice. The system 200 splits the microservice/service into smaller units based on the endpoint paths and results in efficient identification of virtual machines in the registry.

The API gateway module 208 forwards the API request to the virtual machine identified based on the network address received from the service discovery module 210. The API request is routed to the identified virtual machine based on routing algorithms including, but not limited to, round robin, least connection, and IP hashing. In another embodiment, the API gateway module 208 may forward the API request to the orchestrator module 212 and instruct the orchestrator module 212 to create a new virtual machine for the requested API logic when the error message “Not Found” is returned by the service discovery module 210.

The orchestrator module 212 may manage the microservices and the API logics deployed in a distributed architecture and may coordinate interactions between the API logics or the microservices; and may be referred to as orchestrator. The orchestrator module 212 strings together multiple API logics of the microservice to execute a larger workflow or process. The API logics may be private or public. A public API logic may be visible to the client devices 600 operated by consumer/customer clients required to utilize the microservice. In some embodiments, the client device may generate API calls (i.e., API requests) using tools like POSTMAN or Curl to access the corresponding API logics. The private API logics are visible to client devices 600 operated by API owners, API designers, and consumers with explicit rights. The private API logics may be used internally by the microservice, such as, for internal storage or retrieval of data. In some embodiments, a public API logic may generate an API call to access the private API logic. The orchestrator module 212 is configured to deploy both public and private API logics on virtual machines created either at the resource pool 300 or the cloud service provider 400.

Further, the orchestrator module 212 manages the microservices and/or the API logics by creating appropriate virtual machines in accordance with the API configuration information and the computational requirements. In an embodiment, the orchestrator module 212 may configure multiple API logics on a single virtual machine by assigning multiple paths to the single virtual machine. However, the multiple API logics configured on the virtual machine are mutually disjunct and if required, may communicate with each other through API calls.

The orchestrator module 212 may receive an instruction from API gateway to create the new virtual machine for the requested API logic. The instruction includes the API request comprising the path and may also include additional information related to the requested API logic. The orchestrator module 212 may create the new virtual machine either at the resource pool 300 or at the cloud service provider 400 for the path and may configure the new virtual machine with the requested API logic received from the application server 500.

Specifically, the orchestrator module 212 may obtain an API code corresponding to the API request from the application server 500. Thereafter, store the obtained API code in a secured storage (for example a second virtual machine storage 304-2 of FIG. 2A) accessible only to the new virtual machine (for example a second virtual machine 302-2 of FIG. 2A). The new virtual machine may be configured based on the obtained API code stored in the secured storage of the new virtual machine. The orchestrator module 212 may register the new virtual machine corresponding to the path at the service discovery module 210 for discovery.

Further, the orchestrator module 212 may maintain a group of parameters for all the virtual machines configured with the API logics. The group of parameters include, but are not limited to, a path of an API logic mapped with a virtual machine. The orchestrator module 212 may assign a synchronization flag to the path of the API logic mapped to the virtual machine. In some embodiments, the synchronization flag may be a Boolean value represented by ‘1’ or ‘0’. Boolean value 1 may indicate that a virtual machine is configured to receive updates for an API logic. Boolean value 0 may indicate that the virtual machines is not configured to receive updates for the API logic. When a status of the synchronization flag for the path is ‘1’, the orchestrator module 212 may receive a modified API logic from the application server 500 and reconfigures the corresponding virtual machine with the modified API logic corresponding to the path. When the status of the synchronization flag for the path is ‘0’, the orchestrator module 212 may indicate that the virtual machine for the path is not configured to receive any modified API logic. The synchronization flag may be assigned to the path for a first predetermined time. In some embodiments, the synchronization flag status may be a Boolen value represented by ‘TRUE’, ‘FALSE’, and ‘NULL’, in which, ‘TRUE’ status corresponds to the Boolean value ‘1’, ‘FALSE’ corresponds to Boolean value ‘0’, and ‘NULL’ indicates an error or no synchronization or may indicate that virtual machine status is not available for the path.

The orchestrator module 212 may be configured to receive from the application server 500 a modified API code corresponding to the path having the synchronization flag status as ‘1’. After obtaining the modified API code of the path, the orchestrator module 212 may replace the API code stored in the secured storage, herein referred to as the “jailed root”, of the virtual machine registered for the path with the modified API code or may identify one or more differences between the API code and corresponding the modified API code and update the API code with the one or more identified differences. Once the secured storage is updated with the modified API code, the orchestrator module 212 reconfigure the virtual machine with the modified API logic. The reconfiguration of virtual machine includes building the modified API logic based the modified API code and re-initializing application process in the virtual machine with modified API logic. Further, the orchestrator module 212 may delete the existing virtual machine(s) after a second predetermined time of inactivity. The deletion of existing virtual machine includes deletion of corresponding details from the registry of the service discovery module 210. A deletion of an existing virtual machine may also result in deletion of the corresponding secure storage.

Based on above, the orchestrator module 212 may perform application orchestration, microservice orchestration, and network orchestration. In one embodiment, the system 200 may configure dedicated virtual machines at the resource pool 300 or at the cloud service provider 400 for each of the API gateway module 208, the service discovery module 210, and the orchestrator module 212.

The resource pool 300 may be coupled to the system 200 through the network interface 206. The resource pool 300 may provide scalable computational resources and/or storage(s). Referring to FIG. 2A, an exemplary illustration of an implementation of the resource pool 300 is disclosed. The resource pool 300 may have physical computational resource(s) 302 and physical storage(s) 304. The physical computational resource 302 may be referred to as a host virtual machine which hosts multiple guest virtual machines. For example, the resource pool 300 includes a set of guest virtual machines 302-1, 302-2, 302-3, . . . , 302-N, hereinafter referred to as virtual machines. The virtual machines 302-1, 302-2, 302-3, . . . , 302-N are configured to deploy one or more API logics.

In some embodiments, the virtual machines 302-1, 302-2, 302-3, . . . , 302-N may have dedicated and secured storage spaces assigned in the physical storage 304 by the system 200 or by the host virtual machine 302. The physical storage 304 includes a set of virtual machine storages 304-1, 304-2, 304-3, . . . , 304-M corresponding to the virtual machines 302-1, 302-2, 302-3, . . . , 302-N. Accordingly, a first virtual machine storage 304-1 corresponds to the first virtual machine 302-1, where the first virtual machine storage 304-1 may have access restricted to the first virtual machine 302-1 and to the system 200. Similarly, a second virtual machine 302-2 and a third virtual machine 302-3 may have secured storage spaces at a second virtual machine storage 304-2 and a third virtual machine storage 304-3, respectively. In some embodiment, the first virtual machine storage 304-1, the second virtual machine storage 304-2, and the third virtual machine storage 304-3 may also be referred to as jailed roots.

In some embodiments, the resource pool 300 may be an arrangement of plurality of host virtual machines 302 where each host virtual machine may be configurable with one or more guest virtual machines (302-1, 302-2, 302-3, 302-N). The host virtual machines 302 include underlying hardware that provides computing and network resources to support the guest virtual machines. Further, the data corresponding to a guest virtual machine (for example, the first virtual machine 302-1) is stored in a secured storage (for example first virtual machine storage 304-1). The guest virtual machine has a dedicated secured storage configured either on a host virtual machine on which the guest virtual machine has been created or in a database in which dedicated memory is allocated to the guest virtual machine. The secured storage can only be accessed by the corresponding guest virtual machine or by the orchestrator module 212 of the system 200 for transferring data to the guest virtual machine from the application server 500. The orchestrator module 212 may create, manage, monitor, and delete the guest virtual machines on the host virtual machines 302 of the resource pool 300. In an example implementation, a guest virtual machine having 1 Giga bytes (GB) Random Access Memory (RAM), 0.5 Central Processing Unit, and 5 GB disk space requirements may be running inside a host machine having 16 GB RAM, 16 CPU, 120 GB disk space.

Each guest virtual machine may have an IP address and a corresponding MAC address assigned by the host virtual machines or by a virtual manager application which may be configured at the orchestrator module 212, the host, or the load balancer module 214. In some embodiments, the virtual machines 302-1, 302-2, 302-3, . . . , 302-N may correspond to the guest virtual machines and virtual machine storages 304-1, 304-2, 304-3, . . . , 304-M may correspond to the secured storages.

The host virtual machine 302 may have a synchronization agent to manage the guest virtual machines 302-1, 302-2, 302-3, . . . , 302-N. When the secure storages 304-1, 304-2, 304-3, . . . , 304-M are created corresponding to the guest virtual machines 302-1, 302-2, 302-3, . . . , 302-N, the synchronization agent runs between the host virtual machines and the corresponding guest virtual machines. The synchronization agent may be provided with the IP address of the guest virtual machines and the synchronization agent may be configured to determine the linkage between the secure storage 304-1, 304-2, 304-3, . . . , 304-M and the corresponding guest virtual machines 302-1, 302-2, 302-3, . . . , 302-N based on the IP address. In some embodiments, the synchronization agent may be configured to monitor any changes to files stored in the secure storage 304-1, 304-2, 304-3, . . . , 304-M and sync or incorporate the changes to the corresponding guest virtual machines 302-1, 302-2, 302-3, . . . , 302-N. In some embodiments, the service discovery module 210 may track the guest virtual machine IP addresses, and the orchestrator module 212 may track the host IP addresses and paths. In some embodiments, the synchronization agent may be continuously synchronizing data between the secured storages and the corresponding guest virtual machines. In some embodiments, the synchronization agent or the orchestrator module 212 may delete the secure storage upon deletion of a guest virtual machine.

Further, the orchestrator module 212 is configured to update the first virtual machine storage 304-1 with the modified first API logic (i.e. the orchestrator module 212 copies the modified first API code in the first virtual machine storage 304-1), and the synchronization agent is configured to synchronize the first virtual machine 302-1 with the modified first API logic. The synchronization agent may implement synchronization framework to reconfigure the first virtual machine 302-1 with modified first API logic. In some embodiments, the synchronization framework may be based on disk-based synchronization or virtual machine polling using an event-streaming broker. The event-streaming broker may detect any change in state of an application code stored in the first virtual machine storage 304-1 and thereafter may trigger the synchronization of the first virtual machine 302-1 by transferring updates based on the modified API code to the first virtual machines.

Table-2 below illustrates a mapping between the API logical address, associated synchronization status, and the host virtual machines. The mapping of Table-2 is managed by the orchestrator module 212.

TABLE 2

| | | Synchronization | Host Virtual |
|---|---|---|---|
| | | Flag | Machine Address |
| S. | Lookup Key | (STATUS: | (HOST IP: |
| No. | (API logical address) | TRUE/FLASE) | PATH) |
| 1. | jd- | TRUE | 172.178.1.1:/root/ |
| | dev.users.exmproject.com/ | | ere-ece-dfd- |
| | users/list rev: 21 lang: js | | weer/home |
| 2. | jd- | TRUE | 172.178.1.1:/root/ |
| | dev.users.exmproject.com/ | | ere-ece-w34w- |
| | users/list rev: 20 lang: rust | | ddd/home |
| 3. | jd- | TRUE | 172.178.1.2:/root/ |
| | dev.data.exmproject.com/ | | ere-ece-sdf- |
| | sources/list rev: 22 | | wedv33/home |

An API logical address in Table-2 includes a path of API logic. When the synchronization flag status is true for an API logic address, the orchestrator module 212 is configured to receive modified API code corresponding to the API logic address from the application server 500 and forward the modified API code to a host virtual machine determined from the mapping provided in Table-2. The host virtual machine directs the modified API code to be copied in a virtual machine storage of a guest virtual machine, associated with the API logical address. In an example implementation, the orchestrator module 212 may store both host virtual machine IP address details and guest virtual machine IP address details in Table-2.

Further, the resource pool 300 includes a load balancer 306. The load balancer 306 distributes the incoming network traffic volume across multiple severs or virtual machines. Alternatively, the load balancer functionality may be provided in the system 200, as load balancer module 214, instead of the resource pool 300. In some embodiments, the orchestrator module 212 or the API gateway module 208 may implement the load balancer functionality. Based on an incoming traffic volume and based on the feedback from the load balancer 214 or 306, the orchestrator module 212 may create more than one virtual machine for an API logic to prevent overloading of the virtual machine, for example, serial numbers 1, 4, and 6 of Table-1 indicate that two virtual machines have been configured for a single API logic. Accordingly, the load balancer 214 or 306 may distribute the incoming traffic volume (API requests) between the two virtual machines.

In an embodiment, two virtual machines, for example, the first virtual machine 302-1 and the second virtual machine 302-2, may be configured to deploy the first API logic. Accordingly, the service discovery module 210 may provide two IP addresses corresponding to the two virtual machines configured to execute the first API request received from the client device 600. The API gateway module 208 may determine from the load balancer 214 or 306 an appropriate IP address among the two IP addresses to execute the API request. The load balancer 214 or 306 may provide the appropriate IP address based on the traffic volume received on the two IP addresses corresponding to the two virtual machines configured to execute the first API request. Thereafter, the API gateway module 208 may forward the first API request to the appropriate IP address.

In another embodiment, the service discovery module 210 may determine the appropriate IP address from the load balancer 306 and provide the appropriate IP address to the API gateway module 208 for executing the first API request. In some embodiments, the load balancer 306 may suggest the appropriate IP address based on a load balancing logic. The load balancing logic may be based on the incoming network traffic volume.

The cloud service provider 400 may be coupled to the system 200 through the network interface 206. The cloud service provider 400 may provide on-demand and scalable computational resources. Cloud-based service models may be defined as infrastructure-as-a-service (IaaS), platform as a service (PaaS), or software as a service (SaaS). The system 200 may be configured to create on demand virtual machine(s) either using the resource pool 300 or the cloud service provider 400. The system 200 may be configured create virtual machine(s) at strategic geographic location(s) using the cloud service provider 400. In some embodiments, the strategic geographic location may correspond to a geographic location of the client device 600 that initiates the API request, to reduce latency.

The application server 500 communicates with the system 200 and the client device 600. The client device 600 may be operated by a software developer (hereinafter referred to as developer) creating an application using software development service(s) provided by the application server 500, when in a development environment. In the development environment, the developer may create and store the one or more API logics on the Application server 500 and may deploy the one or more API logics on the system 200 for the purpose of testing. In some embodiments, the developer may modify the one or more API logics or create new versions of an API logic stored at the Application server 500 and accordingly, deploy the modified API logic or a new version of the API logic at the system 200. In the development environment, the client device 600 may be referred to as the developer's device to create or modify an application. The application server 500 provides a platform to the client device 600 to create, modify, and manage one or more applications for a service. Alternatively, the client device 600 may be operated by a user generating and sending API request(s) to the system 200 for accessing one or more service. The system 200 may be configured to communicate with multiple client devices.

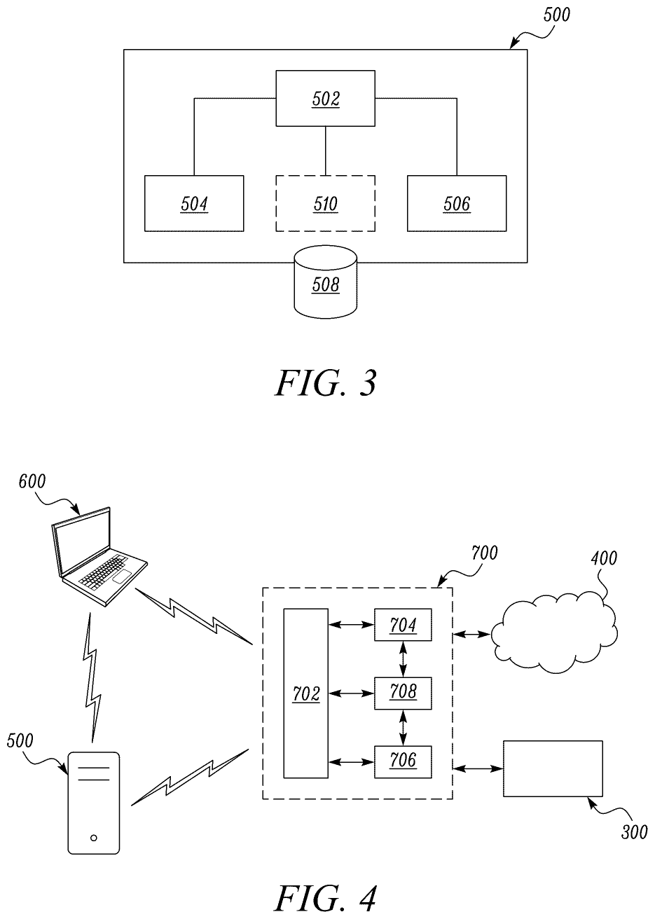

Referring to FIG. 3 an exemplary illustration of an implementation of the application server 500 is disclosed. In some embodiments, the application server 500 may include a processing module 502, a memory 504, a network interface 506, and a database module 508.

The application server 500 may receive application information related to one or more applications to be created and/or stored from the client device 600. The application information may be in form of a code written in one or more programming languages and API configuration information, including, but not limited to, middleware, environment variables, runtime configuration details, logs, and metric collection details. In some embodiments, the application server 500 may also provide a no-code platform or a low code platform to enable the developers create the applications more efficiently. In some embodiments, predefined templates and/or functional or “drag-and-drop” components may be provided via a graphical user interface to the developer operating the client device 600. In some embodiments, the predefined templates may also include one or more functional components including, but not limited to, Model-view-controller with CRUD methods, application framework generated boilerplates, openapi specification driven API skeletons.

In some embodiments, the application server 500 may provide multiple interfaces for developing the application. In some embodiments, the application server 500 may receive an API logic from the client device 600. The API logic may define a portion of the microservice or a complete microservice. In one embodiment, the API logic may include a combination of the functional components and/or the functional components of the predefined templates included by the developer via the graphical use interface of the no-code or low code platform. In another embodiment, the application server 500 may provide software development platform and accordingly, the API logic may be code written in one or more programming languages including, but not limited to, python, Go (Golang), C sharp, C++, R, Java, Perl, Ruby, Scala, Javascript, HTML, PHP, SQL and provided by the developer via the client device 600.

In an example implementation, the application server 500 may dynamically generate custom templates including different functional components for implementation by the developer via the no-code/low code platform. In some embodiments, the application server 500 may also implement one or more artificial intelligence algorithms that may be provided with one or more template related inputs manually by the developer and in response, the AI algorithms may be capable of generating on-demand and/or editable customized templates based on the template related inputs for the developer to implement via the GUI. In some embodiments, the application server may be configured to enable editing of the templates by the developers via GUI and to save the finalized API logic in the database module 508.

In some embodiments, the application server 500 stores the API logic in an intermediate data format, including, but not limited to JavaScript Object Notation (JSON) or Yet Another Markup Language (YAML). Specifically, the developer provides the API logic, selects API configuration information provided by the application server 500 via the GUI, and defines a path (for example: prod.users.exmproject.com/users/list) to access the API logic. In some embodiments, the path may include a domain name. In some embodiments, the path may be defined as Universal Resource Locator (URL) or Universal Resource Identifier (URI). The application server 500 stores the API logic in the database module 508. In some embodiments, the database module 508 may be a storage server, a cloud server, a network node, or a data center coupled to the application server 500. The database module 508 may provide storage services to the application server 500. The database module 508 may assist the application server 500 in developing and testing the microservice or an API logic of the microservice. The database module 508 may also assist in moving the stored data to a cloud storage or to the system 200 for deployment of the microservice or the API logic. The movement of data from the database module 508 may be initiated either by the application server 500 or on a request received from the system 200, specifically, from the orchestrator module 212 of the system 200.

In some embodiments, the application server 500 may include a code generator module 510, hereinafter referred to as a “code generator”. The code generator 510 may generate one or more lines of code based on the API logic stored in the intermediate format. The generated code may be in a developer defined or predefined programming language. In some embodiments, the code generator may directly convert the preconfigured templates and components, configured by the developer to create an API logic including the set of codes in the developer-defined or predefined programming language. With the code generator 510, a single API logic may be deployed on various platforms to support one or more requirements of the developer. In some embodiments, the application server 500 may have multiple code generators for conversion of the API logic codes to different programming languages respectively.

In some embodiments, one or more developers may simultaneously work on a same API logic and therefore, multiple versions of an API logic may be managed by the application server 500. The application server 500 may manage versioning of the API logics stored in the database module 508. The versioning of the API logics may correspond to one or more code versions of the API logics. For example, when the first API logic having the first path stored in the database module 508 is modified by a first developer, in one embodiment, the application server 500 may update the first API logic when a modification to the first API logic is made by the first developer. In another embodiment, the application server 500 may assign a version number to the modified first API logic and may store the modified first API logic as a separate API logic with the version number assigned to the modified first API logic and the first path to access the modified API logic may be a combination of domain name and version number. Therefore, the first API logic may have multiple versions which are uniquely identified by the version number and each version may be defined by a unique path. For instances when the application server 500 receives a request to access the first API logic from the system 200 and the request does not include or specify a version number associated with the first API logic, the application server 500 provides a latest version of the first API logic in response to the request received from the system 200. When a first file of the first API logic is saved in the databased module 508 of the application server 500, the first file may be referred to as a root or a first version. Thereafter, the application server 500 may assign a second version to a second file stored in the database module 508 for the first API logic. The second file may be the modified first API logic and may be referred as the latest version of the first API logic. Both the first file and the second files have common first path and are differentiated by the version numbers.

In some embodiments, the application server 500 may provide an option to the developer at the client device 600 either to update the first file of the first API logic with the modified code of the modified API logic or to create the second file with the modified first API logic. The application server 500 checks status of the synchronization flag corresponding to the first path from the orchestrator module 212 of the system 200, when the first file of the first API logic is updated with the modified API logic.

The processing module 502 of the application server 500 receives from the client device 600, an API logic and a path associated with the API logic or a modification to the API logic at the given path. The processing module 502 stores the API logic in the database module 508. In some embodiments, the processing module 502 may also determine the status of the synchronization flag assigned by the orchestrator module 212 corresponding to the path of the API logic. In some embodiments, the processing module 502 may be configured to request the orchestrator module 212 to provide the status of the synchronization flag associated with the path of the API logic. The path may include, but is not limited to, a combination of a domain name and the version number associated with the API logic. In response, the orchestrator module 212 provides the status of the synchronization flag to the processing module 502. Based on the determination of the status of the synchronization flag, the processing module 502 provides to the orchestrator module 212 the API code and the API configuration information corresponding to the path of the API logic.

Further, when the processing module 502 receives the modified API logic from the client device 600, the processing module 502 updates the API logic corresponding to the path stored the database module 508 of the application server 500 with the modified API logic. The processing module 502 may then determine the status of the synchronization flag corresponding to the path with the orchestrator module 212. Based on the determined status of the synchronization flag, the processing module 502 provides, to the orchestrator module 212, the modified API code corresponding to the path. Further, the processing module 502 converts the API logic to an API code before sending the API logic/modified API logic to the orchestrator 212.

In some embodiments, the processing module 502 is configured to receive a request for API code periodically or in real-time corresponding to the path from the orchestrator module 212 for the API code. The processing module 502 may then configured to provide the API code to the orchestrator module 212 based on the request. The request may include a version number, a target programming language, a combination of the version number, and/or a target programming language associated with the API logic corresponding to the path.

In one embodiment, the processing module 202 of the system 200 or the processing module 502 of the application server 500 may be a combination of plurality of processors implemented in a predefined architecture. In another embodiment, the processing module 202 or 502 may be implemented as virtual machines to handle different volumes of API requests. For example, more than one virtual machine may be configured in real-time to implement the processing module 202 when the API requests from client devices 600 exceed a predetermined amount or when a delay in responding to the API requests exceeds a predetermined time. In some embodiments, the processing modules 202 and 502 may fetch and execute computer-readable instructions stored in the memories 204 and 504, respectively, coupled to the processing module 202 and 502.

The network interface 506 provides a means for processing module 503 to establish a network connection with external entities including, but not limited to, the system 200 and client device 600.

In some embodiments, the application server 500 may be provided in the system 200. Accordingly, the system 200 and the application server 500 may be a single entity that may enable the client device 600 to develop and deploy API logics directly via the system 200.

In some embodiments, the system 200 may configure a virtual machine with one or more API endpoints individually as opposed to the traditional model of running the whole service or building the API endpoints. As shown in FIG. 2B, the first virtual machine 302-1 may be configured with the first API logic, a second API logic, and a third API logic. Similar to the first API logic, the second API logic and the third API logic may be associated with a second path and a third path respectively. The system 200 is configured to move any one of the first API logic, the second API logic, or the third API logic from the first virtual machine 302-1 to another existing virtual machine or to a newly created virtual machine in the resource pool 300 or the cloud service provider 400.

The API gateway module 208 may monitor a volume of the API requests managed by existing virtual machines and may monitor virtual machine utilization parameters associated with the existing virtual machines. The monitored volume and the virtual machine utilization parameters are stored in a monitoring storage (not shown in figures) managed within the system 200 or at the resource pool 300 or at the cloud service provider 400. The virtual machine utilization parameters may include a response time of a virtual machine corresponding to the API request(s), a resource or bandwidth utilization associated with each API request configured on the virtual machines, count/volume of API requests and a count of instances of receiving the modified API codes at the virtual machine.

For instances, when any one of the monitored virtual machine utilization parameters are determined to be above a respective predefined threshold limit, the orchestrator module 212 may be configured to identify at least one candidate API logic from the multiple API logics configured on a virtual machine. In some embodiments, for example, the candidate API logic may be identified when a response time of the candidate API logic is greater than a threshold response time, the resource or bandwidth utilization is greater or lower than a threshold resource utilization, the count of instances of receiving the modified API codes from the application server 500 is greater or lesser than a predetermined count of instances, and/or the volume of the one or more API requests is greater or lesser than a threshold volume.

The orchestrator module 212 may remove the candidate API logic from the virtual machine and may configure the candidate API logic on a candidate virtual machine identified from the existing virtual machines or may create a new virtual machine which may be configured with the candidate API logic. The orchestrator module 212 may select the candidate virtual machine which meets computational capability required for deploying the candidate API logic. The orchestrator module 212 may compare historical usage pattern/data of the candidate virtual machine (the volume of the API requests managed by the candidate virtual machine and the monitored virtual machine utilization parameters of the candidate virtual machine) with historical pattern/data of the candidate API logic stored in the monitoring storage.

The orchestrator module 212 may generate a candidate path for the candidate API logic, assign the candidate path to the candidate virtual machine(s), and copy a candidate API code of the candidate API logic from the jailed root of the virtual machine to the jailed root of the candidate virtual machine or may obtain the candidate API code from the application server 500. Further, the orchestrator module 212 initializes the candidate virtual machine configured with the candidate API logic. The candidate virtual machine along with the candidate path may be registered by the service discovery module.

For example, FIG. 2B is an exemplary illustration of transferring a third API logic from the first virtual machine 302-1 to the third virtual machine 302-3 in the resource pool 300, in accordance with some embodiments of the present disclosure. For instance, the orchestrator module 212 determines the third API logic in the first virtual machine 302-1 as the candidate API logic to be removed and deleted from the first virtual machine 302-1. The orchestrator module 212 may determine the third virtual machine 302-3 as the candidate virtual machine and the third path as the candidate path. Thereafter, the orchestrator module 212 may configure the third virtual machine 302-3 with the third API logic. In an example implementation, the third virtual machine 302-3 may be an existing virtual machine or a newly created virtual machine in the resource pool 300. Thereafter, the orchestrator module 212 may delete the third API logic from the first virtual machine 302-1. Alternatively, the orchestrator module 212 may keep the third API logic active on both the first virtual machine 302-1 and the third virtual machine 302-3 to handle volumes of requests for the third API logic. Accordingly, orchestrator module 212 may register the third virtual machine 302-3 with the service discovery module 210 with the third path according to Table-1.

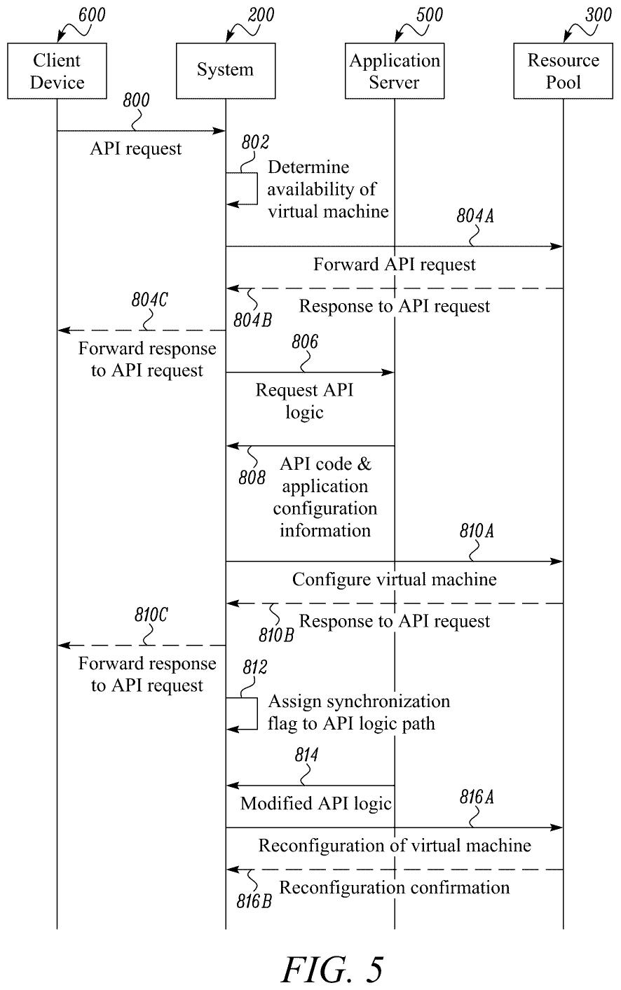

In some embodiments, the system 200 may be implemented in a distributed architecture with multiple individual computing systems, such as servers. For example, referring to FIG. 4, an exemplary illustration of a second environment including a system 700 for iterative application development is disclosed. The system 700 may be similar to and/or include similar hardware and/or software modules configured to perform similar functions as the system 200 (see FIG. 1). For example, the system 700 may include the API gateway 702, the service discovery 704, the orchestrator 706, and the load balancer 70. Accordingly, the API gateway 702, the service discovery 704, the orchestrator 706, and the load balancer 708 may be configured to perform functions of the API gateway module 208, the service discovery module 210, the orchestrator module 212, and the load balancer module 214 of the system 200.

In some embodiments, the load balancer 708 monitors the volume of network traffic based on the volume of incoming API requests at the API gateway 702, service discovery 704, the orchestrator 706, the virtual machines configured at the resource pool 300 and/or at the cloud service provider 400. The load balancer 708 efficiently distributes the incoming network traffic volume across multiple severs or virtual machines. In some embodiments, each API gateway 702, the service discovery 704, the orchestrator 706, and the load balancer 708 may be implemented as individual physical devices, including, but not limited to, servers and may communicate with each other through predefined network interfaces. In some embodiments, the system 700 may have multiple instances of the API gateway 702, the service discovery 704, the orchestrator 706, and the load balancer 708 to manage large incoming volume of network traffic.

The API gateway 702 may be configured to receive multiple API requests from multiple client devices 600. When the API gateway 702 receives the first API request to access the first API logic from the client device 600, the API gateway 702 requests the service discovery 704 to provide details of the first virtual machine 302-1 configured with the first API logic. The first virtual machine 302-1 may be configured at the resource pool 300 or at the could service provider 400. The service discovery 704 determines whether the first path for accessing the first API logic has been active in the registry and may identify that the first virtual machine 302-1 has been assigned for the first path. When the service discovery 704 provides the network address of the first virtual machine 302-1, the API gateway 702 forwards the API request to the first virtual machine 302-1. The first virtual machine 302-1 processes the received API request and sends a response based on the received API request to the API gateway 702. Further, the API gateway 702 forwards the response corresponding to the received API request to the client device 600.

For instances when the service discovery 704 determines that the first path for accessing the requested API logic is unavailable in the registry and that the first virtual machine 302-1 cannot not be identified, the service discovery 704 sends an error message to the API gateway 702. Thereafter, the API gateway 702 forwards the first API request to the orchestrator 706 to create the second virtual machine 302-2 for processing the first API request. The orchestrator 706 creates the second virtual machine 302-2 for the first path. The second virtual machine 302-2 is configured with the first API logic received from the application server 500. For creating the second virtual machine 302-2, the orchestrator 706 obtains the first API code corresponding to the first API logic from the application server 500. The orchestrator 706 sends a request for the first API code to the application server 500. The request includes reference to the first path for the first API logic and also to version number, when the version number has been included in the first API request received by the API gateway 702 from the client device 600.

In response to the request from the orchestrator 706, the application server 500 determines whether the first API logic corresponding to the first path and the version number has been stored in the database module 508 of the application server 500. For instances when the application server 500 determines that the first API logic is stored in the database module 508, the application server 500 converts the first API logic into the first API code and sends the first API code and corresponding application configuration information to the orchestrator 706. The orchestrator 706 obtains the first API code and the application configuration information from the application server 500, creates the second virtual machine 302-2 at the resource pool 300 or at the could service provider 400, and stores in the first API code and API configuration information in the second virtual machine storage 304-2 of the second virtual machine 302-2. Thereafter, the second virtual machine 302-2 is configured according to the first API code. The configuration of the second virtual machine 302-2 may be performed by the orchestrator 706 or by the host virtual machine 302 hosting the second virtual machine 302-2. In some embodiments, the second virtual machine 302-2 created by the orchestrator 706 is configured to have computational requirements as defined in the application configuration information of the first API logic.

The orchestrator 706 registers the second virtual machine 302-2 with the service discovery 704 along with the first path. Further, the orchestrator 706 stores the status of the first API logic and assigns a synchronization flag to the first path, as illustrated in Table-2. For instances when the first API logic is modified in the application server 500 by the developer, the application server 500 updates the first API logic with the modified first API logic and determines the status of synchronization flag corresponding to the first path from the orchestrator 706. For instances, when the status of the synchronization flag corresponding to the first path is determined to be ‘TRUE’ from the orchestrator 706, the application server 500 converts the modified first API logic into the modified first API code and pushes the modified first API code to the orchestrator 706. For instances when the status of the synchronization flag corresponding to the first path is determined to be ‘FALSE’ from the orchestrator 706, the application server 500 does not push the modified first API code to the orchestrator 706.

For instances when the orchestrator 706 receives the modified API logic and the modified first API code from the application server 500, the orchestrator 706 reconfigures either the first virtual machine 302-1 or the second virtual machine 302-2 with the modified first API code of the first API logic depending on which of the two virtual machines 302-1 and 302-2 is configured with the first API logic. Accordingly, the response to the first API request may be provided to the client device 600 based on the modified first API logic for subsequent API requests after the reconfiguration of the first virtual machine 302-1 or the second virtual machine 302-2 with the modified first API logic. The reconfigured first virtual machine 302-1 or the reconfigured second virtual machine 302-2 may process the first API request according to the modified first API logic and generate an output based on or by executing the API logic code associated with the first API logic.

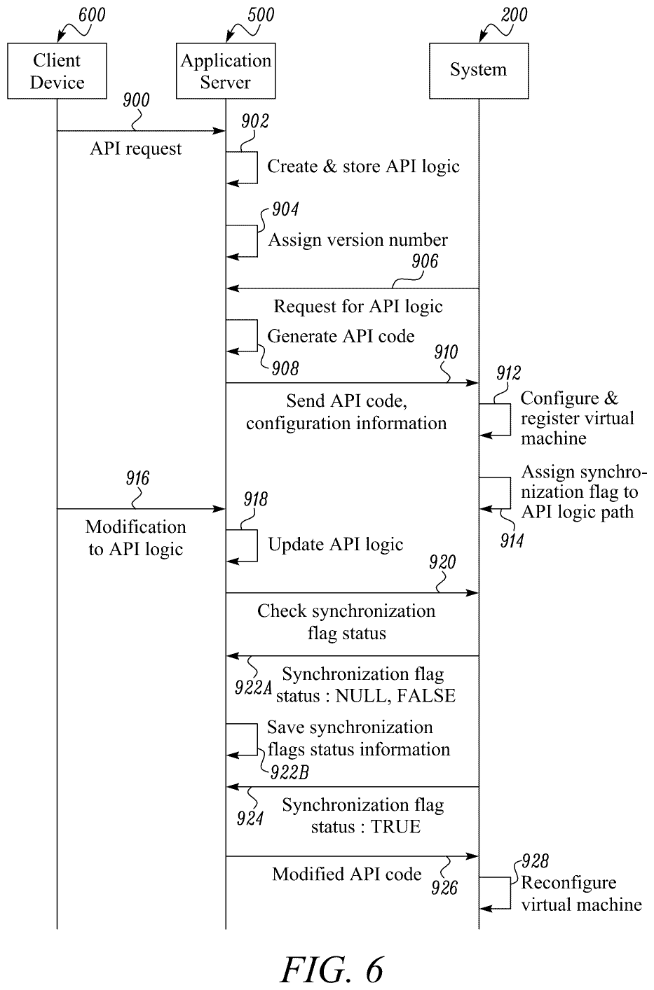

Referring to FIG. 5, an exemplary illustration of a sequence diagram of a process for request driven API deployment via the system 200 of FIG. 1 is disclosed. At step 800, the system 200 receives the first API request from the client device 600. The first API request may include a version number of the first API logic and/or a target programming language associated with the first API logic. In some embodiments, the first path may include a combination of a domain name and the version number associated with the first API logic. At step 802, the system determines an availability of the existing first virtual machine 302-1 configured with the first API logic.

In one embodiment, at step 802, the system 200 determines that the first virtual machine 302-1 is available and configured with the first API logic. Thereafter, at step 804A, the system 200 sends the first API request to the first virtual machine 302-1 created at the resource pool 300. At step 804B, the first virtual machine 302-1 processes the first API request and provides a response corresponding to the first API request by generating an output and providing the output to the system 200. At step 804C, the system 200 forwards the response received from the first virtual machine 302-1 to the client device 600.

In another embodiment, at step 802, the system 200 determines that the first virtual machine 302-1 and/or any other virtual machine is unavailable or not configured to handle or manage the first API request. At step 806, the system 200 sends a request to the application server 500 to obtain the first API logic which is based on the first path provided in the first API request. At step 808, the system 200 obtains the first API code corresponding to the first API request from the application server 500. The application server 500 generates the first API code by converting the first API logic into a first target programming language. The application server 500 may be configured to convert the API logic into multiple programming languages and the first programming language may be one of the programming languages. Further, the system 200 also obtains application configuration information of the first API logic from the application server at step 808.

At step 810A, the system 200 creates the second virtual machine 302-2 for the first path when the existing first virtual machine 302-1 for the first path is unavailable. In some embodiments, the system 200 may perform the steps 808 and 810A simultaneously. The second virtual machine 302-1 created is configured with the first API logic received from the application server 200, at step 808. For configuring the second virtual machines 302-1 with the first API logic, the system 200 stores the obtained first API code in the second virtual machine storage 304-2 with an access restricted to the second virtual machine 302-2. The second virtual machine 302-2 gets initialized with the first API code stored in the second virtual machine storage 304-2. Further, the system 200 registers the second virtual machine 302-2 corresponding to the first path for virtual machine discovery.

Thereafter, the system 200 forwards the first API request to the second virtual machine 302-2. The second virtual machine 302-1 executes the first API request based on the first API code and provides a response to the system 200 at step 810B after executing the first API request. The system 200 forwards the response received from the second virtual machine 302-2 to the client device 600 at step 810C. As result, the system 200 may be able to implement the on-demand deployment of the application on a virtual machine.

At step 812, the system 200 assigns a synchronization flag to the first path. The status of the synchronization flag enables receiving of the modified first API code from the application server 500 for instances when the developer make changes to the first API logic and the changes to the first API logic are saved in the application sever 500.

When the application server 500 receives a modification in the first API logic from the client device 600. The application server 500 updates the first API logic with the modified API logic. During the modification, the first path remains consistent and may uniquely identify the API logic during communications between the system 200, the application server 500, and the client device 600. A modification to the first API logic triggers the application server 500 to determine the synchronization flag status of the first path with the system 200. For instances when the system 200 responds to the application server 500 with status as ‘TRUE’, the application server 500 pushes the modified first API logic to the system 200.

At step 814, the system 200 receives the modified first API logic corresponding to the first path from the application server 500. At step 816A, the system 200 reconfigures the existing first virtual machine 302-1 or the second virtual machine 302-2 for the first path based on the modified first API logic. The system 200 determines the virtual machine among the virtual machines 302-1 to 302-N configured with the first API logic based on the first path. For example, the system 200 determines that the second virtual machine 302-2 is configured with the first API logic and updates the second virtual machine storage 304-2 with the modified first API code. The modified first API code may be generated by the application server 500 by converting the modified first API logic into the first target programming language. Further, the system 200 updates the second virtual machine storage 304-2 by replacing the first API code stored prior to the update with the modified first API code or by identifying one or more differences between the first API code stored prior to the update and the modified first API code and updating the first API code the one or more identified differences. At step 816B, the system 200 receives a confirmation that the reconfiguration of the second virtual machine 302-2 based on the modified first API logic has been successful from the host virtual machine 302 of the resource pool 300. Accordingly, upon receiving any further request for the first API logic from the client device 600, the system 200 provides an output based on the modified first API logic via the reconfigured first virtual machine 302-1 or the reconfigured second virtual machine 302-2.

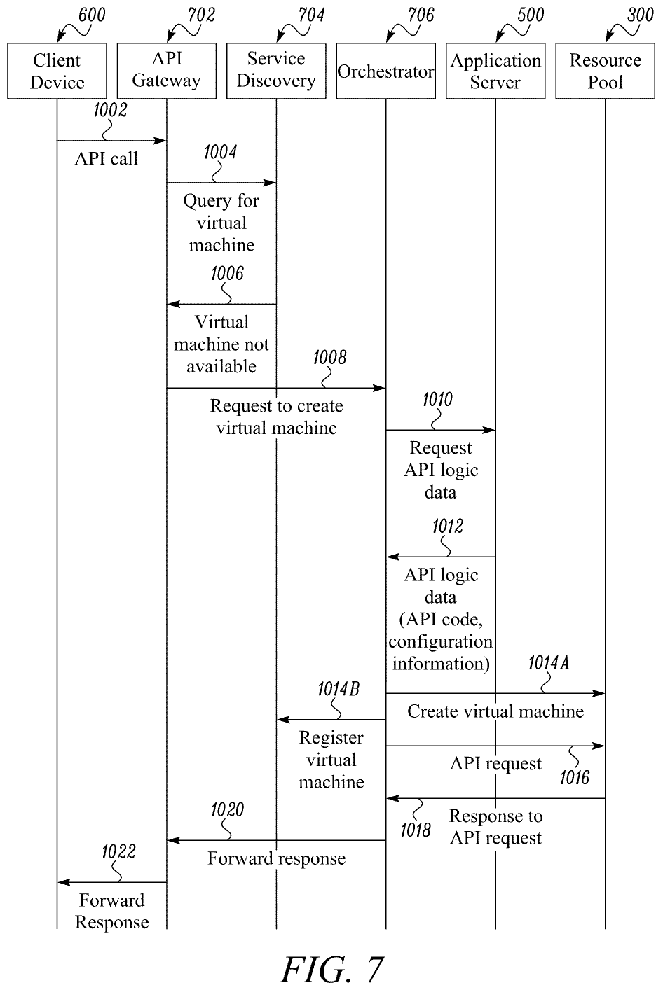

Referring to FIG. 6, an exemplary illustration of a sequence diagram of a process for creating an API logic and a deployment thereof is disclosed. At step 900, the application server 500 receives information including, but not limited to, an application logic, application configuration information, and a path for accessing the application from the client device 600. At step 902, the application creates the API logic based on the information received at step 900 and stores the API logic in the database module 508.

The application server 500 determines whether the path provided by the client device 600 is preconfigured for the microservice. The application server 500 assigns a version number to the API logic when the path is determined to be preconfigured for the microservice at step 904. At step 906, the application server 500 receives a request for the API logic from the system 200. The request from the system 200 may include the path identifying the API logic and one or more additional information like, but not limited to a version number or a target programming language associated with the API logic corresponding to the path.

The application server 500 determines whether the API logic is available for the requested path identified in the request received from the system 200, in step 906. For instances when the API logic is unavailable, the application server 500 provides an error message to the system 200. When the API logic corresponding to the requested path is identified, the application server 500 converts the API logic into an API code at step 908. Further, at step 910, the application server 500 sends the API code and the application configuration information to the system 200 based on the request received at step 906.

At step 912, the system 200 creates, configures, and registers a virtual machine based on the information received at step 910. Further, at step 914, the system 200 assigns a synchronization flag to the path registered with the virtual machine created at step 912.

At step 914, the application server 500 receives a modification to the API logic corresponding to the path. At step 918, the application server 500 updates the API logic corresponding to the path. At step 920, the application server 500 determines the synchronization flag status for the path from the system 200.

At step 922A, the application server 200 receives the synchronization flag status from the system 200. For instance, when the synchronization flag status is determined to be ‘NULL’ from the system 200, the application server 500 determines unavailability of a virtual machine for the path. For instance, when the synchronization flag status is ‘FALSE’, the application server 500 determines that the virtual machine exists for the path, but the virtual machine cannot be reconfigured with the modified API logic. For instance, when the synchronization flag status is ‘TRUE’, the application server 500 determines that the virtual machine exists for the path and the virtual machine is available for reconfiguration with the modified API logic.

In one embodiment, when the synchronization flag status is determined to be ‘NULL’ or ‘FALSE’ at step 922A, the application server 500 stores the synchronization flag status information in the database module 508 corresponding to the path.

In another embodiment, when the synchronization flag status is determined to be ‘TRUE’ at step 924, the application server 500 generates a modified API code based on the updated API logic stored in the database module 508 at step 918 and sends the modified API code to the system 200 at step 926. At step 928, the system 200 reconfigures the virtual machine with the received modified API code corresponding to the path having synchronization flag status as ‘TRUE’.

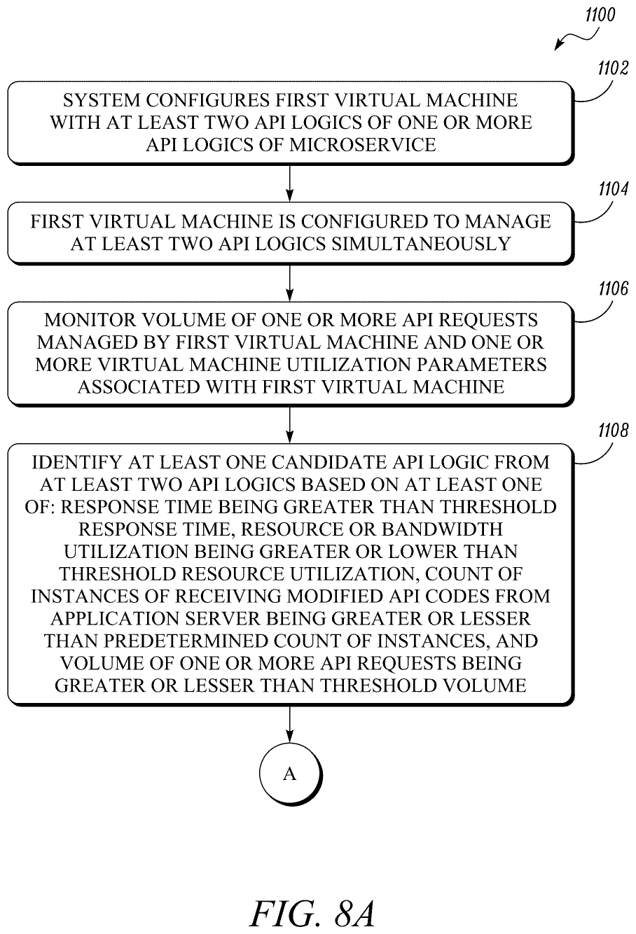

Referring to FIG. 7, an exemplary illustration of a sequency diagram of a process for request driven API deployment is disclosed. At step 1002, the API gateway 702 receives an API call. The API call is the first API request which includes the first path defined to access the first API logic of the microservice. Further, the API call includes a version number of the first API logic and/or a target programming language associated with the first API logic. The first path may be a combination of a domain name and the version number associated with the first API logic.

At step 1004, the API gateway 702 queries the service discovery 704 to determines the first virtual machine 302-1 configured with the first API logic based on the API call. At step 1006, the API gateway 702 receives an error message from the service discovery 704 indicating unavailability of the first virtual machine 302-1 to execute the first API request. At step 1008, the API gateway 702 requests the orchestrator 706 to create the second virtual machine 302-2 to execute the first API request. At step 1010, the orchestrator 706 requests the application sever 500 to provide the first API code and application configuration information based on the first API request.

At step 1012, the application server 500 provides the first API code and the application configuration information corresponding to the first API logic. At step 1014A, the orchestrator 706 creates the second virtual machine 302-2 at the resource pool 300 and configures the second virtual machines with the first API logic. At step 1014B, the orchestrator 706 registers the second virtual machine 302-2 at the service discovery 704. Alternatively, the orchestrator 706 may create the second virtual machine 302-2 at the cloud service provider 400.

At step 1016, the orchestrator 706 forwards the first API request received from the API gateway 702 to the second virtual machine 302-2 configured at the resource pool 300. In some embodiments, the orchestrator 706 informs the API gateway 702 about the availability of the second virtual machine 302-2 configured to execute the first API request. The API gateway 702 may send a query to the service discovery 704 for the first API request and step 1004 may be repeated. The service discovery 704 may respond to the query by providing network address of the second virtual machine 302-2 and the API gateway 702 may forward the API request to the second virtual machine 302-2 based on the network address received from the service discovery 704.

At step 1018, the orchestrator 706 receives a response to the first API request from the second virtual machine 302-2 configured with the first API logic. At step 1020, in some embodiments, the orchestrator 706 forwards the response to the API gateway 702. In some embodiments, the second virtual machine 302-2 may also send the response to the first API request directly to the API gateway 702 by bypassing the orchestrator 706. At step 1022, the API gateway forwards the response to the client device 600.

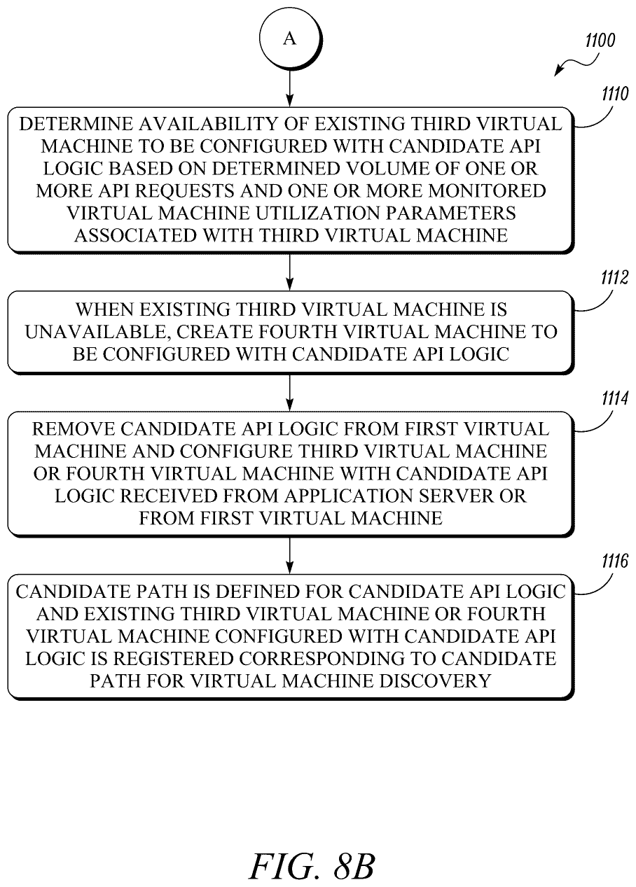

Referring to FIGS. 8A and 8B an exemplary flowchart of a method 1100 for managing plurality of API logics on the first virtual machine 302-1 is disclosed. The method 1100 may be implemented by the system 200 or by the system 700. Referring to FIG. 8A, at step 1102, the first virtual machine 302-1 is configured by the system 200, 700 with at least two API logics of the one or more API logics. The at least two API logics are bundled and accessible through their respective paths. For example, the at least two API logics may be the first API logic the second API logic, and the third API logic (See FIG. 2B) and may be accessed by the first path, the second path, and the third path respectively.

At step 1104, the first virtual machine 302-1 is configured to manage the at least two API logics simultaneously. At step 1106, a volume of the one or more API requests managed by the first virtual machine 302-1 and one or more virtual machine utilization parameters associated with the first virtual machine 302-1 are monitored by the system 200, 700. The monitored volume and the one or more monitored virtual machine utilization parameters are stored in the monitoring storage. The virtual machine utilization parameters may include, but are not limited to, a response time of the first virtual machine 302-1 corresponding to the first or different API requests, a resource or bandwidth utilization associated with each API request, and a count of instances of receiving the modified API codes.

At step 1108, at least one candidate API logic from the at least two API logics is identified by the system 200, 700, for removal or deletion from the first virtual machine 302-1. For example, the third API logic may be the candidate API logic. The candidate API logic may be identified based on the monitored virtual machine utilization parameters. For example, the candidate API logic may be identified based on the response time being greater than a threshold response time, the resource or bandwidth utilization being greater or lower than a threshold resource utilization, the count of instances of receiving the modified API codes from the application server being greater or lesser than a predetermined count of instances, and/or the volume of the one or more API requests being greater or lesser than a threshold volume.

Referring to FIG. 8B, at step 1110, the system 200, 700 determines an availability of the existing third virtual machine 302-3 (see FIG. 2A) to be configured with the candidate API logic (i.e. the third API logic) based on the determined volume of the one or more API requests and the monitored virtual machine utilization parameters associated with the third virtual machine 302-3.

At step 1112, a fourth virtual machine to be configured with the candidate API logic is created by the system 200, 700 when the existing third virtual machine 302-3 is determined to be unavailable at step 1110.

At step 1114, the candidate API logic is removed from the first virtual machine 302-1 by the system 200, 700 and the third virtual machine 302-3 or the fourth virtual machine may be configured with the candidate API logic received from the application server 500 or from the first virtual machine 302-1, based on the steps 1110 and 1112.

At step 1116, a candidate path is defined for the candidate API logic by the system 200, 700 and the existing third virtual machine 302-3 or the fourth virtual machine configured with the candidate API logic is registered corresponding to the candidate path for virtual machine discovery. For instances when the third API logic is determined to be the candidate API logic, then the third path corresponds to the candidate path.

The present disclosure describes example systems and methods for application development and application deployment in an application development environment as well as in a production environment. The systems and methods provide request driven application deployment. Thus, the systems 200, 700 and the methods of the present disclosure enable a microservice to be split into individual API logics and enable configuration of the complete microservice through paths defined to access the API logic. As a result, each API logic may be deployed on demand. Accordingly, only the requested API logic may be deployed instead of the complete microservice or the bundle of API logics. Therefore, a response to the API request may be provided in lesser time as compared to deploying a bundle of API logic or the microservice. Accordingly, any modification to one API logic of the microservice would prevent redeployment of the complete microservice or the entire bundle of API logics. Further, the virtual machines may be utilized more efficiently for an API logic of the microservice which receives higher number of API requests as compared with the API requests received for the other API logics of the same microservice. Further, as the API logics are individually deployed instead of a bundle of API logics or as a complete microservice, configuration of a virtual machine with an API logic and execution of the API logic upon a request may be efficient as the volume of code is less and resource requirement would also be less.

Further, frequent modifications of one or more API logics within the microservice would be efficiently handled by the systems and methods of the present disclosure. The frequent modification of API logics may either result in updating an API logic with same path or a new version of the API logic may be created where the path remains the same and the new API logic may be identified by the combination of the path and the version number. Thus, based on the API call/request from the client device 600 to the API gateway module 208 or API gateway 702, a specific API logic may be executed. Further, the splitting of the microservice would reduce the resource utilization as virtual machines would be active for the frequently requested API logics and further virtual machines would be configured when new API calls are received by the systems. Furthermore, the modified API logic or a new version of an API logic may be integrated with the complete microservice more efficiently. As a result, the microservice would utilize minimal resources and may also reduce the costs in utilizing the cloud resources.

Moreover, any error or failure in the execution of the modified API logic or the new version of the API logic do not render the complete microservice or the bundle of the API logic unresponsive, and resultantly the microservice may continue to respond to API requests for remaining API logics.

The preferred embodiments of the present disclosure will be described in conjunction with the accompanying drawings, it should be understood that the preferred embodiments described herein are only used to illustrate and explain the present disclosure and are not intended to limit the present disclosure. While several examples are described in the description, modifications, adaptations, and other implementations are possible. Accordingly, the following detailed description is not limited by the disclosed examples.

References to “some embodiment”, “an embodiment”, “at least one embodiment”, “one example”, “an example”, “for example”, “another example” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in some embodiment” does not necessarily refer to the same embodiment.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

I claim:

1. A system for iterative application development comprising:
a processor configured to:
receive, from a client device, a first application program interface (API) request corresponding to a first API logic, wherein the first API request includes a first path to access the first API logic;
determine an availability of an existing first virtual machine configured with the first API logic or create a second virtual machine for the first path when the existing first virtual machine for the first path is unavailable, wherein the second virtual machine created is configured with the first API logic;
receive a modified first API logic corresponding to the first path from the application server;
reconfigure the existing first virtual machine or the second virtual machine for the first path based on the modified first API logic; and
provide, to the client device, an output based on the modified first API logic via the updated existing first virtual machine or the updated second virtual machine.

2. The system as claimed in claim 1, wherein the first API request comprises a first logical address associated with the first API logic, and wherein the first logical address comprises the first path and at least one of: a version number of the first API logic, a target programming language associated with the first API logic, and a runtime configuration of the first API logic.

3. The system as claimed in claim 2, wherein the processor is configured to create the second virtual machine by:
obtaining, from the application server, a first API code corresponding to the first API request, wherein the first API code is generated by converting the first API logic into the first target programming language;
configuring the second virtual machine based on the first API code obtained; and
registering the second virtual machine corresponding to the first path for virtual machine discovery.

4. The system claimed in claim 3, wherein the processor is configured to:
store the obtained first API code in a second virtual machine storage with an access restricted to the second virtual machine; and
assign a synchronization flag to the first path, wherein a status of the synchronization flag enables receiving of a modified first API code from the application server, wherein the modified first API corresponds to the modified first API logic.

5. The system as claimed in claim 4, wherein the synchronization flag is assigned to the first path for a first predetermined time.

6. The system as claimed in claim 3, comprising a no-code platform for inputting one or more user interface elements associated with the first API logic.

7. The system as claimed in claim 4, wherein the processor is configured to:
update the second virtual machine storage with the modified first API code, wherein the modified first API code is generated by converting the modified first API logic into the first target programming language, and wherein the processor is configured to update the second virtual machine storage by:
replacing the first API code stored prior to the update with the modified first API code; or
identifying one or more differences between the first API code stored prior to the update and the modified first API code; and
updating the first API code prior to the updated with the one or more identified differences.

8. The system as claimed in claim 1, wherein the processor is configured to delete the existing first virtual machine or the second virtual machine after a predetermined time of inactivity of the existing first virtual machine or the second virtual machine.

9. The system as claimed in claim 3, wherein the processor is configured to:
configure the first virtual machine with at least two API logics, wherein the at least two API logics are bundled and accessed through respective unique paths;
configure the first virtual machine to manage the at least two API logics simultaneously; and
monitor a volume of API requests managed by the first virtual machine and one or more virtual machine utilization parameters associated with the first virtual machine, wherein the monitored volume and the one or more monitored virtual machine utilization parameters are stored in a monitoring storage.

10. The system as claimed in claim 9, wherein the one or more virtual machine utilization parameters comprise a response time of the first virtual machine corresponding to the plurality of first or different API requests, a resource or bandwidth utilization associated with each API request, and a count of instances of receiving the modified API codes.

11. The system as claimed in claim 10, wherein, based on at least one of:
the response time being greater than a threshold response time,
the resource or bandwidth utilization being greater or lower than a threshold resource utilization,
the count of instances of receiving the modified API codes from the application server being greater or lesser than a predetermined count of instances, and
the volume of the API requests being greater or lesser than a threshold volume, the processor is configured to identify at least one candidate API logic from the at least two API logics to be removed from the first virtual machine.

12. The system as claimed in claim 11, wherein the processor is configured to:
determine an availability of an existing third virtual machine to be configured with the candidate API logic based on the determined volume of the API requests and the one or more monitored virtual machine utilization parameters associated with the third virtual machine or create a fourth virtual machine to be configured with the candidate API logic when the existing third virtual machine is unavailable, wherein the fourth virtual machine created is configured with the candidate API logic received from the application server or from the first virtual machine;
remove the candidate API logic from the first virtual machine;
define a candidate path for the candidate API logic; and
register the existing third virtual machine or the fourth virtual machine corresponding to the candidate path for virtual machine discovery.

13. The system as claimed in claim 2, wherein the processor determines the availability of the existing first virtual machine configured with the first API logic from a registry, and wherein the registry maintains a mapping between logical addresses of API logics and network addresses of corresponding virtual machines configured with the API logics.

14. A method for iterative application development, the method comprising:
receiving, from a client device, a first application program interface (API) requests corresponding to a first API logics, wherein the first API request includes a first path to access the first API logic;
determining an availability of an existing first virtual machine configured with the first API logic received corresponding to the first path from an application server or creating a second virtual machine for the first path when the existing first virtual machine for the first path is unavailable, wherein the second virtual machine created is configured with the first API logic received from the application server;
receiving a modified first API logic corresponding to the first path from the application server;
reconfiguring the existing first virtual machine or the second virtual machine for the first path based on the modified first API logic; and
providing, to the client device, an output based on the modified first API logic via the updated existing first virtual machine or the updated second virtual machine.

15. An application server, comprising:
a processor configured to:
receive, from a client device, an application program interface (API) logic and a path associated with the API logic;
determine a status of a synchronization flag assigned by an orchestrator corresponding to the path of the API logic; and
provide, to the orchestrator, an API code and an API configuration information corresponding to the path of the API logic based on the status of the synchronization flag.

16. The application server as claimed in claim 15, wherein the processor is configured to:
receive, from the client device, a modified API logic corresponding to the path of the API logic;
update the API logic, corresponding to the path, stored in a database of the application server with the modified API logic;
determine the status of the synchronization flag corresponding to the path; and
provide, to the orchestrator, the modified API code corresponding to the path based on the status of the synchronization flag.

17. The application server as claimed in claim 16, wherein the processor is configured to convert the API logic to the API code.

18. The application server as claimed in claim 16, wherein the processor is configured to request the orchestrator to provide the status of the synchronization flag associated with the path of the API logic, and wherein the path comprises a combination of a domain name and the version number associated with the API logic.

19. The application server as claimed in claim 15, wherein the processor is configured to:
receive a request corresponding to the path from the orchestrator for the API code; and
provide the API code to the orchestrator based on the request.

20. The application server as claimed in claim 19, wherein the request comprises at least one of a version number, a target programming language, or a combination of the version number and a target programming language associated with the API logic corresponding to the path.

21. A method implemented by an application server, the method comprising:
receiving, from a client device, an application program interface (API) logic and a path associated with the API logic;
determining, from an orchestrator, a status of a synchronization flag assigned by the orchestrator corresponding to the path of the API logic; and
providing, to the orchestrator, an API code and an API configuration information corresponding to the path of the API logic based on the status of the synchronization flag.

22. The method as claimed in claim 21, wherein the method comprises:
receiving, from the client device, a modified API logic corresponding to the path of the API logic;
updating the API logic, corresponding to the path, stored in a database of the application server with the modified API logic;
determining the status of the synchronization flag corresponding to the path; and
providing, to the orchestrator, the modified API code corresponding to the path based on the status of the synchronization flag.
